(19) United States
(12) Patent Application Publication
(10) Pub. No.: US 2010/0257566 A1
(43) Pub. Date: Oct. 7, 2010

(54) BROADCAST STORAGE ARRANGEMENT

(75) Inventor: Tuomas Mikael Matila, Tampere (FI)

Correspondence Address: DITTHAVONG MORI & STEINER, P.C., 918 Prince Street, Alexandria, VA, 22314, US

(73) Assignee: Nokia Corporation, Espoo (FI)

(21) Appl. No.: 12/813,266

(22) Filed: Jun. 10, 2010

Related U.S. Application Data
(63) Continuation of application No. 10/918,777, filed on Aug. 12, 2004, now abandoned.

(30) Foreign Application Priority Data
Aug. 15, 2003 (FI) PCT/FI2003/000606

(51) Int. Cl. H04N 7/16; H04B 1/66

(52) U.S. Cl. 725/62; 375/240.01

(57) ABSTRACT

Broadcast storage arrangement in a telecommunication network, the arrangement comprising a broadcast service provider (TV), a distribution network (NW, DVB), and at least one mobile node (MN). A broadcast transmission provided by the broadcast service provider is compressed and delivered in a form suitable for mobile node reception via the distribution network to the mobile node. The mobile node sends a request to a server (SRV) functionally connected to the broadcast service provider to save at least a part of said broadcast transmission in a less compressed format. Then the server is arranged to save at least a part of said broadcast transmission in a less compressed or uncompressed format.

### FIELD OF THE INVENTION

The invention relates to broadcast services, more particularly to a broadcast storage arrangement.

### BACKGROUND OF THE INVENTION

Along with the digitalisation of various broadcast services, like terrestrial, cable and satellite TV and radio broadcasts, some totally new transmission routes and receiving terminals have become viable solutions. For instance, TV and radio broadcasts over the Internet to a personal computer (PC) provided with suitable hardware/software are well known applications. Over the past few years, the ability to receive broadcast transmissions also in handheld devices and wireless terminals, like mobile telephones, has become more desirable.

There are several possibilities to deliver the broadcast data content to a wireless terminal. For instance, the US patent application US2002/0065074 discloses a server-based system comprising a single use content server and a repeated use content server. A single use content server stores and sends data that can only be used once by a particular user, like real-time TV and radio broadcasts. A repeated use content server stores and sends data that can be accessed repeatedly by a user, like various video clips. In response to an order from the terminal, the content data of these servers is delivered to a proxy server, which forwards the data through a data network, like Internet and a packet radio network, to a transmission device, such as a base station of a mobile network. The multimedia data is then transmitted wirelessly to the terminal, which comprises a storage area and a memory subsystem for storing, playbacking and managing the multimedia data.

Additionally, the Applicant's prior application EP 1168880 discloses a network arrangement with an IP-based transfer network and multiple alternative wireless access networks for transferring broadcast services to a wireless subscriber device.

Mobile networks have been designed for point-to-point services and transmissions. In order to maximize the user capacity of a mobile network, the bandwidth of a traffic channel is very limited. Thus, one feature in common with all solutions, wherein broadcast data content is delivered to a wireless terminal, is that the multimedia data to be transmitted must be heavily compressed in order to fit in the channel, on the one hand, and to be playbacked and managed with the limited processing and memory capacity of the terminal, on the other hand.

One of the disadvantages associated with the above arrangement is that the heavy compression impairs the quality of the multimedia data. Typically both video and audio resolution are significantly degraded with a lossy compression. Thus, the received multimedia data, while being satisfactorily usable in a wireless terminal, is typically not useful in devices, like PC or TV set, with better resolution and other higher quality video and audio characteristics. This poses a significant disadvantage, if the terminal user, while receiving an interesting broadcast, wishes to save at least part of the broadcast as a video clip to be accessed later on with another playback device.

### BRIEF DESCRIPTION OF THE INVENTION

The present invention seeks to provide an improved method and an improved apparatus for alleviating the above disadvantages. The objects of the invention are achieved by a method, a telecommunication network arrangement, a network element, a mobile terminal and a computer program, which are characterized by what is stated in the independent claims. Some embodiments of the invention are disclosed in the dependent claims.

The invention is based on the idea of managing broadcast data content in a telecommunication network arrangement comprising a broadcast service provider, a distribution network and at least one mobile node, whereby at least one broadcast transmission provided by the broadcast service provider is compressed and delivered in a form suitable for mobile node reception via the distribution network to the mobile node. The mobile node subscriber, if being further interested in said broadcast transmission, sends a request from the mobile node to a server functionally connected to said broadcast service provider to save at least a part of said broadcast transmission in a less compressed format. Said server then saves the at least a part of said broadcast transmission in a less compressed or uncompressed format.

According to an embodiment, the saved part of less compressed broadcast transmission is processed in said server according to at least one of the following options: saving the saved part of less compressed broadcast transmission in a database comprised by said server; saving the saved part of less compressed broadcast transmission in a database of the mobile node subscriber; uploading the saved part of less compressed broadcast transmission to an Internet web-page; or sending the saved part of less compressed broadcast transmission to the mobile node subscriber as an email attachment.

According to another embodiment, the mobile node includes in said save request at least an identity definition of the broadcast to be saved and the duration of the part of the broadcast to be saved. In the save request may be further included at least the definitions of a multimedia file format of the broadcast to be saved, a desired compression level and a definition for further storage or delivery of the saved part of less compressed broadcast transmission.

According to another embodiment, said broadcast transmission is buffered, prior to said compression, in said server in a less compressed or uncompressed format, whereby in response to a request made by the mobile node subscriber, at least a part of the buffered broadcast transmission may be included to the part of the broadcast to be saved.

The method and the arrangement of the invention provide several advantages. A major advantage is that the arrangement provides the mobile node subscriber a possibility to save a broadcast with enhanced video and audio quality for subsequent retrieval by another terminal with better playback characteristics, like a TV set or a personal computer PC. A further advantage is that the mobile node subscriber is provided with various options of how the subsequent retrieval may be carried out, from which options the subscriber may select the one that is most suitable for him/her. Yet another advantage is that, thanks to the buffer memory of the server, broadcasts, which have started a while ago or even finished, may be saved from the very beginning. From the service provider's viewpoint, another advantage is that the invention includes a delivery of a broadcast at least twice, thus enabling additional revenues. Also the price for saving of a part of the broadcast may be set according to the compression level used for saving.

### BRIEF DESCRIPTION OF THE DRAWINGS

In the following the invention will be described in greater detail by means of various embodiments with reference to the accompanying drawings, in which

FIG. 1 shows a block diagram of a network arrangement in which the invention can be used;

FIG. 2 shows a data flow chart illustrating an embodiment of the invention;

FIG. 3 shows a data flow chart illustrating another embodiment of the invention; and

FIG. 4 shows a block diagram of a subscriber terminal in which the invention is used.

### DETAILED DESCRIPTION OF THE INVENTION

As stated above, there are several possibilities to deliver the broadcast data content to a wireless terminal. In the following, an example of the implementation of the invention will be further disclosed in connection with a network arrangement known from the Applicant's prior application EP 1168880. The invention is, however, not limited to such configuration, but it can be implemented in any network arrangement providing compressed broadcast data content to a wireless terminal.

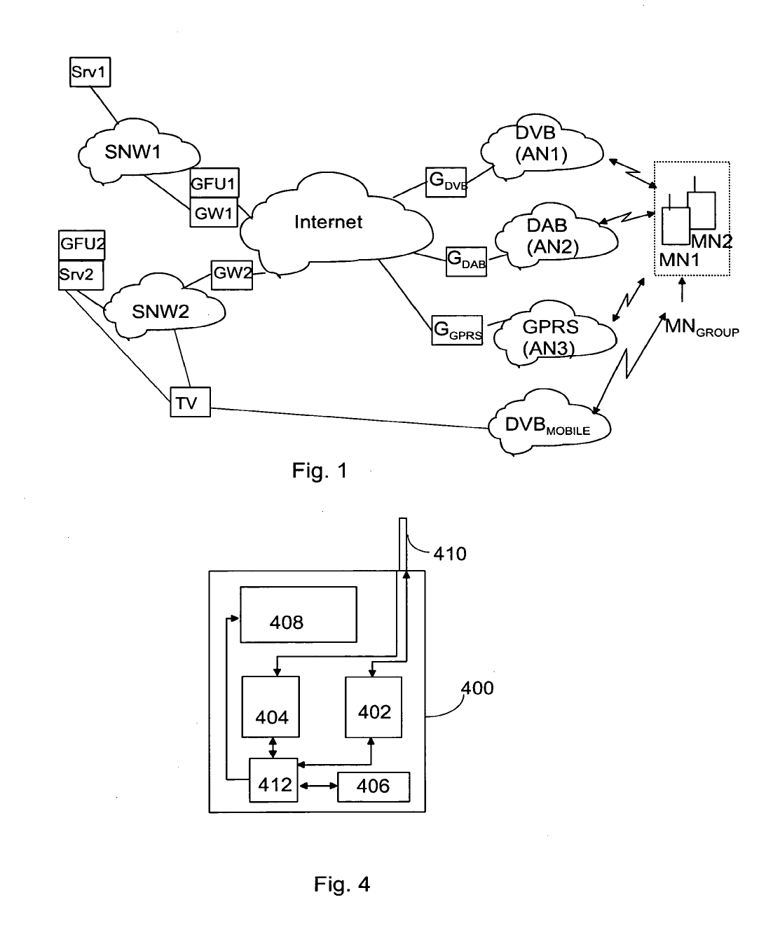

FIG. 1 is a block diagram of a network arrangement in which the invention can be used. The network arrangement, known as such, is configured to provide the mobile nodes MN1, MN2 with broadcast services either as individual point-to-point transmission or as point-to-multipoint multicast transmissions. Mobile nodes MN1, MN2 request broadcast services from one or more servers Srv1, Srv2. The mobile nodes can access the services via several alternative wireless access networks AN1, AN2, AN3. In the example shown in FIG. 1, the access networks comprise a network AN1 enabling digital video broadcasting (DVB), a network AN2 enabling digital audio broadcasting (DAB) and a network AN3 enabling general packet radio service (GPRS). Other typical access networks, especially mobile phone networks such as GPRS, are GSM high-speed circuit switched data (HSCSD), WCDMA (Wideband Code Division Multiple Access), EDGE (Enhanced Data GSM Environment), CDMA2000, or any other equivalent 3G-network (3 Generation) solution. A further example of a wireless access network is a WLAN (Wireless Local Area Network).

In an access network using wireless transmission the total capacity is limited by allocated frequency bandwidth. In this example, the servers Srv1 and Srv2 providing the broadcast data content are connected to their service networks SNW1 and SNW2, which may be a service provider's local area networks, for example. It is generally known that in mobile communication networks, the air interface resources are very limited and the bandwidth typically very narrow, whereas broadcast networks like DAB and DVB have a wider bandwidth. However, also DAB and DVB have, besides the broadcasting, a data service capability with e.g. a 20 Mbyte/s bandwidth. This is wide compared to cellular phone networks but is not sufficient for versatile group transmissions and still far less than available offered services would use (e.g. over a high-speed Internet connection, like ADSL, or regular TV broadcasting). The service network SNW1, SNW2 is connected to the Internet via a gateway GW1, GW2. The access networks AN1, AN2, AN3 are connected to the Internet via corresponding gateways G_{DVB}, G_{DAB}, G_{GPRS}.

Hence, the invention can be used in a network arrangement with multiple alternative wireless access networks for transferring services located at a server to a wireless subscriber device, as shown in FIG. 1. However, the invention is also applicable to a network arrangement with only one access network, such as the GPRS network.

In this network arrangement, the service networks SNW1, SNW2 comprise or are functionally connected to a group formation unit GFU. The group formation unit collects or monitors service requests from the mobile node subscribers MN1, MN2. It evaluates the information of the service requests. If the information has an indication to join to a point-to-multipoint group, the GFU forms a group of the subscribers that have requested the service and transmits (or allows/controls the transmission of) the service as a group transmission (multicast). If the request information has an indication that the preferred transmission mode is individual, the GFU transmits (or allows/controls the transmission of) the service over a sufficient number of individual transmissions (point-to-point) as long as there is allocated bandwidth available.

In the example shown in FIG. 1, the first group formation unit GFU1 is integrated or co-located with the gateway GW1. In this case, if the criteria for group formation are met, the GFU1 requests the gateway to associate the group members with the group. It also requests the appropriate service-providing server Srv1 to send the service to the gateway GW1 such that the destination field of the data packets indicates the group as the recipient. The second group formation unit GFU2 is integrated or co-located with the server Srv2. In this case, if the criteria for group formation are met, the GFU2/Srv2 combination applies source routing to the corresponding destination. If, for instance, subscribers in the DVB network generate requests that indicate group transmission, the GFU2/Srv2 combination directly transmits the service to the gateway G_{DVB} that forwards the service as a group transmission, like multicast. For the details of group formation, a reference is made to EP 1168880.

The capacity control of the access network, and thus the allocation of channels are performed at the base station controller (BSC) in case of a mobile phone network. Capacity control can also be performed by the group forming unit GFU if it is located within the access network and being in connection e.g. with the BSC or base station BS. In case of a multicast transmission, the server would already send the service as a multicast transmission, which is then delivered to the subscribers over the access network.

In addition to the network arrangement disclosed in EP 1168880, FIG. 1 further depicts a broadcast transmission route, wherein existing digital television distribution network DVB_{MOBILE} is utilized in delivering highly compressed TV programs suitable to be received and playbacked by mobile terminals. Thus, no IP-based networks are needed in this embodiment. A television broadcast operator TV provides compressed broadcast delivery for mobile nodes MN via the digital television network multiplex DVB_{MOBILE}. The service provider and its server SRV can be an independent party, or the TV broadcast operator can provide the services, as well. For the sake of illustration, digital television networks DVB_{MOBILE} and the DVB (access network AN1) are shown in FIG. 1 as separate networks, but in practical implementation a common digital television network (terrestrial digital broadcasting network) would preferably be used.

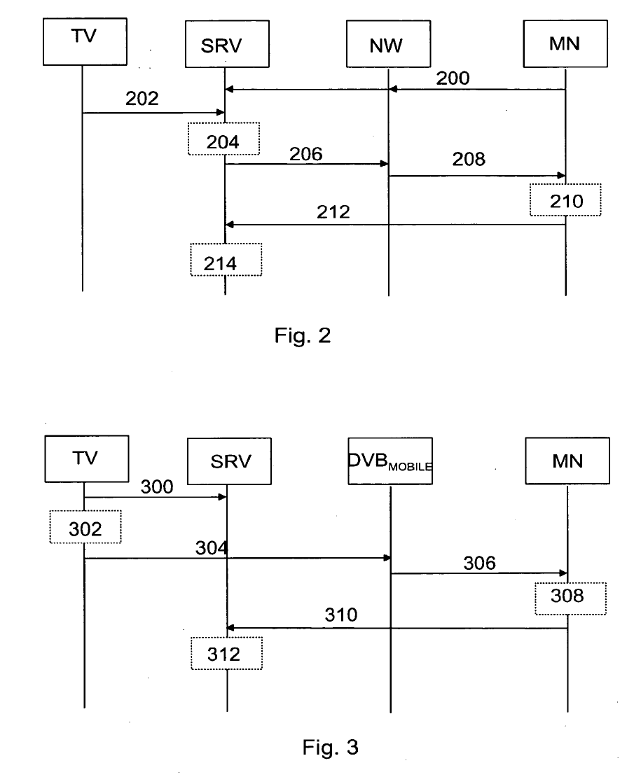

FIG. 2 shows a data flow chart illustrating an embodiment of the invention. In this example, the parties involved are a TV broadcast operator TV and a service provider and its server SRV providing compressed broadcast delivery for mobile nodes MN via a network arrangement NW. Since the invention is not limited by the implementation of the broadcast delivery network, the functionality of the network NW in FIG. 2 denotes all necessary networks and network elements required for broadcast delivery. Thus, if an IP-based transmission media is used, the network NW may comprise, for example in terms of FIG. 1, the service provider's network SNW1, SNW2, corresponding gateways GW1, GW2 to the Internet and the access networks AN1, AN2, AN3 with corresponding Internet gateways G_{DVB}, G_{DAB}, G_{GPRS}.

In this example, the mobile node subscriber MN wishes to access a real-time TV broadcast by his/her mobile terminal. The mobile node subscriber MN sends a service request (200) to the server SRV of the service provider. The service request may be, for example, a service request according to the network arrangement of FIG. 1. The service request may be delivered to the server SRV via the network NW, e.g. as a SIP (Session Initiation Protocol) message via the GPRS connection, or by using some instant messaging or a SMS (Short Messaging Service). The TV broadcast operator TV delivers constantly a real-time TV broadcast (202) to the service provider, which compresses (204) the broadcast in its server SRV into suitable form to be transmitted to mobile nodes MN.

In response to the service request of the mobile node subscriber MN, the service provider evaluates the information of the service request, for example in the group formation unit GFU of FIG. 1. Based on said evaluation, the service provider selects a suitable transmission mode and starts to transmit (206, 208) the broadcast via the network NW to the mobile node MN. The mobile node subscriber MN starts to playback (210) the real-time TV broadcast by his/her mobile terminal. After a while, the subscriber finds the broadcast interesting and decides to save at least a part of it, i.e. a video clip, to be later retrieved by another playback device with enhanced video and audio characteristics. For this purpose, the mobile node subscriber MN sends a save request (212) to the service provider's server SRV. Also this message can be delivered to the server SRV via the network NW, e.g. as a SIP message, or by using some instant messaging or a SMS sent directly to the server. In response to the save request, the server SRV saves (214) the desired clip in a desired storage in uncompressed or at least in less compressed format for further usage. The uncompressed broadcast and the desired clip can be saved either as digitally or analogously formatted, but the broadcast transmitted to the mobile node MN is in a digital format.

According to an embodiment, the save request sent by the mobile node subscriber MN can also be included in the service request (200) sent to the server SRV. Thereby, if the subscriber decides that he/she wants to save a clip of the broadcast without first reviewing it, the server SRV starts saving the clip simultaneously with the broadcast delivery.

There are several options how the saved clip could then be further processed. The server SRV may save the clip in a database connected to the server or in a database of the mobile node subscriber, whose location is either predefined in the subscriber profile or defined in the save request. Alternatively, the clip may be sent to the mobile node subscriber as an e-mail attachment or it could be uploaded to a predefined web-page. The saved clip could also be streamed later on from its location by using a streaming server, from which the recipients retrieve the stored multimedia data by means of a streaming application included in the terminal.

The server SRV preferably includes a buffer memory for buffering the sent broadcast for a time period of at least a few minutes, preferably more. Thereby, the user is provided a possibility to save a broadcast, which has started a while ago, from the very beginning. If the buffer memory is large enough, the user may be provided a possibility to save a broadcast, which has already finished but is still available in the buffer memory.

From the service provider's viewpoint, the less heavily the broadcast is compressed, the larger is the size of the clip, and thereby the more bandwidth capacity is required for delivering the clip to the end user. Therefore, the service provider may preferably set different prices for saving the clip with different compression levels. Thus, an uncompressed clip with the best possible video and audio quality would be more expensive than a clip with smaller size but poorer video and audio quality due to a compression of some degree.

Consequently, the save request message sent by the mobile node should include the necessary definitions for determining at least some of the above options. The save request message should include at least the minimum definitions of the clip to be saved: the broadcast ID and the duration of the clip. The duration can be defined as the start and stop times, or as predefined/immediate start time together with predefined/undefined duration. Additional definitions can include, for example, the desired multimedia file format, the compression level (including possibly certain compression parameters), pasting buffered broadcast for the period of N minutes and the definitions of further delivery (database storage address/e-mail delivery/web-page upload/etc.). The selection of these definitions and the formation of the save request message can preferably be accomplished by an application executed in the mobile terminal. The user interface of the application could preferably resemble a video recorder with buttons and a selection menu familiar to the user, thereby facilitating the usage of the application.

FIG. 3 shows a data flow chart illustrating another embodiment of the invention. Along with the introduction of the digital television DVB, proposals have been made according to which a separate broadcast multiplex or at least some channels of a multiplex could be reserved for mobile broadcast transmission. Consequently, the television operators could use the existing digital television distribution networks to deliver highly compressed TV programs suitable to be received and playbacked by mobile terminals. No IP-based networks are needed in this embodiment. Thus, the parties involved in this example are a TV broadcast operator TV providing compressed broadcast delivery for mobile nodes MN via the digital television network multiplex DVB_{MOBILE}, as depicted in FIG. 1. The service provider and its server SRV provide the storage and delivery service of the less heavily compressed video clips in response to the requests made by the mobile node subscriber MN. The service provider can be an independent party, or the TV broadcast operator can provide said storage and delivery service, as well. This latter option is depicted in FIG. 3 with the dotted line combining the TV broadcast operator TV and the server SRV.

Also in this second example, the mobile node subscriber MN wishes to access a real-time TV broadcast by his/her mobile terminal. The television operator TV typically transmits the broadcast also in uncompressed format, whereby it is constantly delivered to the server SRV (300), as well. The television operator TV compresses (302) the broadcast and transfers (304) it further to the existing digital television distribution network for transmission. The same broadcast is continuously transmitted to the server SRV in uncompressed or less compressed format. Since the broadcast is transmitted (306) via the digital television network multiplex DVB_{MOBILE}, no service requests by the mobile node subscriber MN are needed, but the mobile terminal can be tuned to receive the broadcast. In response to the tuning, the mobile terminal starts to playback (308) the real-time TV broadcast. Again, after a while, the subscriber finds the broadcast interesting and decides to save at least a part of it, i.e. a video clip, to be later retrieved by another playback device with enhanced video and audio characteristics. For this purpose, the mobile node subscriber MN sends a save request (310) to the service provider's server SRV. This message can be delivered to the server SRV via the any viable telecommunication network, e.g. as a SIP message, or by using some instant messaging or a SMS sent directly to the server. In response to the save request, the server SRV saves (312) the desired clip in a desired storage in uncompressed or at least in less heavily compressed format for further usage.

FIG. 4 depicts a block diagram of a subscriber terminal 400 in which the invention is used. The subscriber terminal is the mobile node in the network architecture. The mobile node can be a mobile phone capable of packet data communication, for example GPRS or 3G compatible. A mobile, network transceiver 402 is used for this purpose. The terminal has also a network receiver 404 used to receive broadcast or multicast data, such as DVB or DAB data. A data storage 406 can be a memory unit, for example a flash memory or RAM, hard disk drive and it is used for storing the received data for example, a received data file. An output to be sent from the terminal 400 can be a visible information (such as text, picture or video), audio information (such as sound or voice) or data to be re-transmitted, and is sent by mobile transceiver 402 and antenna 410 to the network. An input coming to the terminal from the network can be received data, such as text, picture, video or audio information and is put to the user via user interface 408. The antenna element 410 can be a duplex mode antenna capable of at least two-frequency operation. The antenna element 410 can also have several antennas within the terminal each operating for the specific network. The operation and timing of all blocks of the terminal 400 is controlled by a central processing unit 412, such as a microprocessor. The various user profile information is stored in the data storage 406 and can be input by the user via user interface 408 comprising e.g. keypad, display, speaker and microphone.

It is to be noted that the functional elements of the terminal according to the invention may be implemented, for example, by means of software, by hardware solutions, or as a combination of the two. The process of defining the clip to be saved according to the invention is particularly suitable for implementation as computer software comprising computer-readable commands for executing the necessary process steps. A way of implementing the process is to store it in a storage means as a program code, i.e. an application, which can be executed by a computer-like device, such as a mobile station, to provide the clip definition functionalities on the device in question.

Thus, the application software may preferably comprise software code for receiving and managing compressed broadcast transmissions, software code for forming a save request to save at least a part of a broadcast transmission in a less compressed format, and software code for transmitting said save request to a server functionally connected to a broadcast service provider.

It will be obvious to a person skilled in the art that as the technology advances, the inventive concept can be implemented in various ways. The invention and its embodiments are not limited to the examples described above but may vary within the scope of the claims.

1-13. (canceled)

14. An apparatus comprising:
a broadcast receiver configured to receive a compressed television transmission,
a mobile communications interface, and
a processor configured to:
control generation of a request to save at least part of the television transmission in an uncompressed format or in a format less compressed than the compressed television transmission; and
determine to send the request via the mobile communications interface to a server capable of receiving the television transmission in an uncompressed format or in a format less compressed than the compressed television transmission.

15. An apparatus according to claim 14, wherein the compressed television transmission is a digital television transmission adapted for reception and playback by a mobile terminal.

16. An apparatus according to claim 15, wherein the compressed television transmission is a DVB_{MOBILE} transmission.

17. An apparatus according to claim 14, wherein the television transmission is a digital video broadcast DVB transmission.

18. An apparatus according to claim 17, wherein the television transmission is adapted for terrestrial transmission.

19. An apparatus according to claim 14, wherein the storing of the television transmission is arranged in an analogue format.

20. An apparatus according to claim 14, wherein the apparatus is configured to send the save request by a session initialization protocol message, an instant messaging message, or a short message service message.

21. An apparatus according to claim 14, wherein the save request comprises a broadcast identifier and an indication of the duration of the at least part of the television transmission to be saved.

22. An apparatus according to claim 21, wherein the request comprises start and stop times.

23. An apparatus according to claim 14, wherein the request comprises compression parameters.

24. An apparatus according to claim 14, wherein the request comprises at least one of the following definitions:
a multimedia file format of the television transmission to be saved;
a desired compression level; and
a definition for further storage or delivery of the less compressed saved part of the television transmission.

25. An apparatus according to claim 14, wherein an application executed in the apparatus is configured to generate the save request.

26. An apparatus according to claim 25, wherein a user interface of the application is configured to resemble a video recorder.

27. An apparatus according to claim 14, wherein the apparatus is further configured to receive the saved at least part of the television transmission from a database defined by a subscriber profile, receive the saved at least part of the television transmission by e-mail, receive the saved at least part of the television transmission by media streaming, or receive the saved at least part of the television transmission from a web page.

28. An apparatus according to claim 14, wherein the apparatus is a mobile terminal.

29. A method comprising:
receiving a compressed television transmission by a broadcast receiver,
generating a request to save at least part of the compressed television transmission in an uncompressed format or in a format less compressed than the compressed television transmission; and
determining to send the request via a mobile communications interface to a server capable of receiving the television transmission in an uncompressed format or in a format less compressed than the compressed television transmission.

30. A method according to claim 29, wherein the save request comprises a broadcast identifier and an indication of the duration of the at least part of the television transmission to be saved.

31. A computer-readable storage medium encoded with software, executable in an apparatus comprising a broadcast receiver and a mobile communications interface, comprising:
software code for determining to receive a compressed television transmission;
software code for generating a request to save at least part of the television transmission in an uncompressed format or in a format less compressed than the compressed television transmission; and
software code for determining to send the request via a mobile communications interface to a server capable of receiving the television transmission in an uncompressed format or in a format less compressed than the compressed television transmission.

32. A computer-readable medium according to claim 31, wherein the save request comprises a broadcast identifier and an indication of the duration of the at least part of the television transmission to be saved.
